(19) United States
(12) Patent Application Publication
(10) Pub. No.: US 2026/0253244 A1
(43) Pub. Date: Aug. 27, 2026

(54) METHOD FOR ANALYZING AND STREAMING USER VIDEOS WITHOUT UPLOAD DELAY

(71) Applicant: ACTNOVA INC., Daejeon (KR)

(72) Inventors: Jong Whoa Lee, Seoul (KR); Ho Chan Jo, Seoul (KR)

(73) Assignee: ACTNOVA INC., Daejeon (KR)

(21) Appl. No.: 19/216,075

(22) Filed: May 22, 2025

(30) Foreign Application Priority Data
Feb. 24, 2025 (KR) 10-2025-0023482

(51) Int. Cl. G06T 7/70; G06V 20/40

(52) U.S. Cl. CPC G06T 7/70; G06V 20/49

(57) ABSTRACT

The present specification relates to a method for analyzing and streaming videos without upload delay by a server, which may include receiving, from a terminal, the videos; generating a segment based on the data of the videos; storing the segment; analyzing the segment; and transmitting an analysis result of the segment to the terminal.

### BACKGROUND FIELD

The present specification relates to a method for analyzing and streaming the videos in question without delay of the videos uploaded to a server.

### DESCRIPTION OF RELATED ART

A process of analyzing a long-duration video by AI techniques requires high computational cost. In particular, such analysis may be inefficient in environments where computing resources of a user terminal are limited, and it is practically impossible to use an AI service for long-duration video without high-performance hardware such as a GPU. To solve this problem, a manner in which a server receives the video from a client, processes a computation on behalf of the client, and transmits the processed result to the client, may be used.

However, even when computation is performed by the server, significant delays may occur due to the capacity of the video and the AI analysis process for each frame. Video data forms a large volume due to high resolution and a high number of frames, and AI processing for each frame requires repetitive and complex computations. As a result, users may experience a long waiting time to check the processed result, which becomes a factor in increasing the user dropout rate.

Therefore, there is a need for a technical solution that analyzes video data in real time and quickly sends results to provide a more user-friendly and immediate environment for result confirmation. Such technology supports users in quickly checking the result for a desired time zone immediately upon uploading a video, thereby enhancing accessibility to AI-based analysis services and enhancing the user experience.

### SUMMARY

### Technical Problem

It is an object of the present specification to implement a method for analyzing video data in real time and sending a result quickly.

Further, it is an object of the present specification to implement a method that supports a user to quickly check a result of a desired time zone as soon as a video is uploaded.

The technical problems to be solved by the present specification are not limited to the above-mentioned technical problems, and other technical problems that are not mentioned will be clearly understood by those skilled in the art in the technical field to which the present specification belongs from the following detailed description of the specification.

### Technical Solution

According to an aspect of the present specification, there is provided a method for analyzing and streaming videos without upload delay by a server, which may include receiving, from a terminal, the videos; generating a segment based on the data of the videos; storing the segment; analyzing the segment; and transmitting an analysis result of the segment to the terminal.

In addition, the generating the segment may include dividing the videos in a fixed time unit.

In addition, the analyzing the segment may include displaying an analysis completion in an item corresponding to the segment based on an array for indicating that analysis of the segment has been completed.

In addition, the analyzing the segment may include estimating a pose of the target through a pose estimation AI model for each frame included in the segment.

In addition, the method may further include receiving, from the terminal, a request for processing a specific segment; checking whether the analysis of the specific segment has been completed; and when the analysis of the specific segment has been completed, transmitting the analysis result of the specific segment to the terminal.

In addition, the method may further include when the analysis of the specific segment has not been completed, loading the specific segment; analyzing the specific segment; and transmitting the analysis result of the specific segment to the terminal.

In addition, the checking whether the analysis of the specific segment has been completed may include retrieving an item corresponding to the specific segment based on the array.

In addition, the method may further include performing the analysis, starting from the last processed frame number.

According to another aspect of the present specification, there is provided a server for analyzing and streaming videos without upload delay, including: a pose estimation AI model configured to analyze the videos; a storage module, configured to store segment data and an analysis result of the videos; a streaming module configured to provide the analyzed video data in real time; and a processor configured to functionally control the pose estimation AI model, the storage module, and the streaming module; wherein the processor may be configured to: receive, from a terminal, the videos, generate, store, and analyze the segment based on data of the videos, and transmit the analysis result of the segment to the terminal.

### Advantageous Effects

According to the embodiments of the present specification, it is possible to implement a method for analyzing video data in real time and rapidly sending the result.

In addition, it is possible to implement a method that supports a user to quickly check a result of a desired time zone as soon as a video is uploaded.

Effects that may be obtained in the present specification are not limited to the above-mentioned effects, and other effects that are not mentioned will be clearly understood by those skilled in the art in the technical field to which the present specification belongs from the following description.

### BRIEF DESCRIPTION OF THE DRAWINGS

FIG. 1 is a block diagram describing an electronic device related to the present specification.

FIG. 2 is a block diagram of an AI device according to an embodiment of the present specification.

FIG. 3 illustrates a streaming system to which the present specification may be applied.

FIG. 4 illustrates an upload process to which the present specification may be applied.

FIG. 5 illustrates metadata to which the present specification may be applied.

FIG. 6 illustrates a pose result array to which the present specification may be applied.

FIG. 7 illustrates a computing process to which the present specification may be applied.

The accompanying drawings, which are included as part of the detailed description to facilitate an understanding of the present specification, provide embodiments of the present specification and, together with the detailed description, explain the technical features of the present specification.

### MODE FOR CARRYING OUT THE INVENTION

Hereinafter, embodiments disclosed in the present specification will be described in detail with reference to the accompanying drawings, and the same or similar components will be given the same reference numerals regardless of the reference numeral and redundant description thereof will be omitted. The suffixes “module” and “unit” for components used in the following description are given or used interchangeably only in consideration of ease of description in preparing the specification, and do not have distinct meanings or roles from each other. In addition, in describing the embodiments disclosed in this specification, detailed descriptions of known related technologies will be omitted if they are deemed to obscure the gist of the embodiments disclosed in the present specification. In addition, it should be understood that the accompanying drawings are merely for facilitating understanding of the embodiments disclosed in the present specification, and are not intended to limit the technical concept disclosed in the present specification by the accompanying drawings, and include all alteration, equivalents, and substitutions included in the concept and technical scope of the present specification.

Terms including ordinal numbers such as first, second, etc. may be used to describe various components, but the components are not limited by the terms. These terms are only used for the purpose of distinguishing one component from another.

It will be understood that when a component is referred to as being “connected” or “coupled” to other component, it may be directly connected or coupled to the other component, but intervening components may also be present. In contrast, when a component is referred to as being “directly connected” or “directly coupled” to other component, it should be understood that there are no intervening components present.

The singular expressions “a,” “an,” and “the” include plural expressions unless the context clearly dictates otherwise.

In this application, it should be understood that terms such as “comprises” or “have” are intended to specify the presence of characteristics, numbers, steps, operations, components, parts, or combinations thereof described in the specification, but do not preclude in advance the possibility of the presence or addition of one or more other characteristics, numbers, steps, operations, components, parts, or combinations thereof.

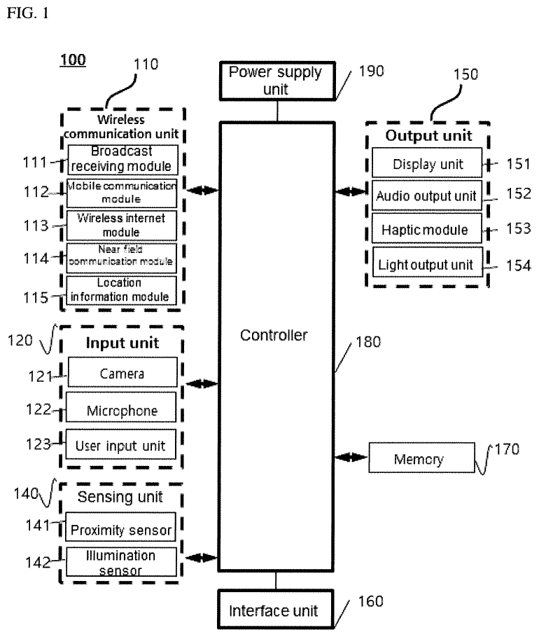

FIG. 1 is a block diagram describing an electronic device related to the present specification.

The electronic device 100 may include a wireless communication unit 110, an input unit 120, a sensing unit 140, an output unit 150, an interface unit 160, a memory 170, a controller 180, a power supply unit 190, and the like. The components shown in FIG. 1 are not essential for implementing the electronic device, so that the electronic device described herein may have more or fewer components than those listed above.

More specifically, the wireless communication unit 110 among the above components may include one or more modules that enable wireless communication between the electronic device 100 and a wireless communication system, between the electronic device 110 and other electronic device 100, or between the electronic device 100 and an external server. In addition, the wireless communication unit 110 may include one or more modules configured to connect the electronic device 100 to one or more networks.

The wireless communication unit 110 may include at least one of a broadcast receiving module 111, a mobile communication module 112, a wireless internet module 113, a near field communication module 114, and a location information module 115.

The input unit 120 may include a camera 121 or a video input unit for inputting video signals, a microphone 122 or an audio input unit for inputting audio signals, and a user input unit 123 (e.g., a touch key, a mechanical key, or the like) for receiving information from a user. The voice data or image data collected by the input unit 120 may be analyzed and processed as a control command from the user.

The sensing unit 140 may include one or more sensors for sensing at least one of information in the electronic device, surrounding environment information surrounding the electronic device, and user information. For example, the sensing unit 140 may include at least one of a proximity sensor 141, an illumination sensor 142, a touch sensor, an acceleration sensor, a magnetic sensor, a gravitation sensor (G-sensor), a gyroscope sensor, a motion sensor, an RGB sensor, an infrared sensor (IR sensor), a finger scan sensor, an ultrasonic sensor, an optical sensor (e.g., a camera; see reference numeral 121), a microphone (see reference numeral 122), a battery gauge, an environmental sensor (e.g., a barometer, a hygrometer, a thermometer, a radiation sensing sensor, a heat sensing sensor, a gas sensing sensor, or the like), and a chemical sensor (e.g., an electronic nose, a healthcare sensor, a biometric sensor, or the like). Meanwhile, the electronic device disclosed in the specification may utilize information sensed from at least two or more of these sensors in combination.

The output unit 150 is for generating output related to visual, auditory, tactile, or the like, and may include at least one of a display unit 151, an audio output unit 152, a haptic module 153, and a light output unit 154. The display 151 may form a mutual layer structure with the touch sensor or may be formed integrally with the touch sensor, thereby implementing a touchscreen. Such touchscreen may function as the user input unit 123 that provides an input interface between the electronic device 100 and user, and may simultaneously provide an output interface between the electronic device 100 and the user.

The interface unit 160 serves as a passage with various kinds of external devices connected to the electronic device 100. The interface unit 160 may include at least one of a wired/wireless headset port, an external charger port, a wired/wired data port, a memory card port, a port connecting a device provided with an identification module, an audio input/output (I/O) port, a video input/output (I/O) port and an earphone port. In the electronic device 100, in response to the external device being connected to the interface unit 160, appropriate control related to the connected external device may be performed.

In addition, the memory 170 stores data for supporting various functions of the electronic device 100. The memory 170 may store a plurality of application programs or applications driven on the electronic device 100, and data and instructions for operating the electronic device 100. At least some of these application programs may be downloaded from the external server via wireless communication. Also, at least some of these application programs may exist on the electronic device 100 from the time of release for basic functions of the electronic device 100 (e.g., incoming and outgoing call functions, message receiving and sending functions). Meanwhile, the application programs may be stored in the memory 170, installed on the electronic device 100, and driven by the controller 180 to perform an operation (or a function) of the electronic device.

In addition to operations related to the application program, the controller 180 typically controls overall operations of the electronic device 100. The controller 180 may provide or process appropriate information or function to the user by processing signals, data, information, or the like input or output through the above-described components or driving the application programs stored in the memory 170.

In addition, the controller 180 may control at least some of the components illustrated in conjunction with FIG. 1 in order to drive the application programs stored in the memory 170. Furthermore, the controller 180 may operate at least two or more of the components included in the electronic device 100 in combination with each other in order to drive the application programs.

The power supply unit 190, under the control of the controller 180, receives external power or internal power and supplies power to each of the components included in the electronic device 100. This power supply unit 190 includes a battery, and the battery may be an embedded battery or a battery in replaceable form.

At least some of the components may operate in cooperation with each other to implement the operation, control, or control method of the electronic device according to various embodiments described below. In addition, the operation, control, or control method of the electronic device may be implemented on the electronic device by driving at least one application program stored in the memory 170.

The electronic device 100 may be collectively referred to herein as the server, and the server may include a cloud server. In addition, the terminal may include all or some configurations of the electronic device 100, and may include a tablet PC.

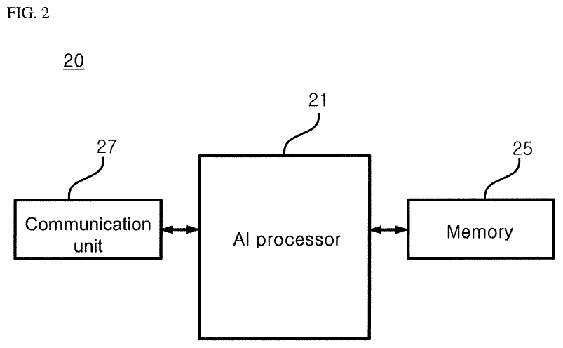

FIG. 2 is a block diagram of an AI device according to an embodiment of the present specification.

The AI device 20 may include an electronic device including an AI module capable of performing AI processing, a terminal including the AI module, or the like. The AI device 20 may also be included in at least some configurations of the electronic device 100 shown in FIG. 1 and may be provided to perform at least some of the AI processing together.

The AI device 20 may include an AI processor 21, a memory 25, and/or a communication unit 27.

The AI device 20 is a computing device capable of learning a neural network, and may be implemented as various electronic devices such as a terminal, a desktop PC, a notebook PC, a tablet PC, and the like.

The AI processor 21 may learn the neural network using a program stored in the memory 25. In particular, the AI processor 21 may include a large-scale pre-learned pose estimation model. For example, the pose estimation model may predict the main key-points of the target in a video frame acquired from the terminal in real time.

On the other hand, the AI processor 21 that performs the functions as described above may be a general-purpose processor (for example, a CPU), but may be an AI-only processor for artificial intelligence learning (for example, GPU, graphics processing unit).

The memory 25 may store various programs and data necessary for the operation of the AI device 20. The memory 25 may be implemented as a non-volatile memory, a volatile memory, a flash-memory, a hard disk drive (HDD), or a solid-state drive (SDD) and the like. The 25 is accessed by the AI memory processor 21, and reading/writing/modifying/deleting/updating and the like of data by the AI processors 21 may be performed. In addition, the memory 25 may store the neural network model (for example, a deep learning model) generated through a learning algorithm for data classification/recognition according to an embodiment of the present specification.

Meanwhile, the AI processor 21 may include a data learning unit that learns the neural network for data classification/recognition. For example, the data learning unit may learn the deep learning model by acquiring learning data to be used for learning and applying the acquired learning data to the deep learning model.

The communication unit 27 may send the AI processing result by the AI processor 21 to the external electronic device.

The external electronic device may include another terminal or a terminal.

Meanwhile, although the AI device 20 illustrated in FIG. 2 has been described as being functionally divided into the AI processor 21, the memory 25, the communication unit 27, and the like, the above-described components may be integrated into one module and may be referred to as an AI module or an artificial intelligence (AI) model.

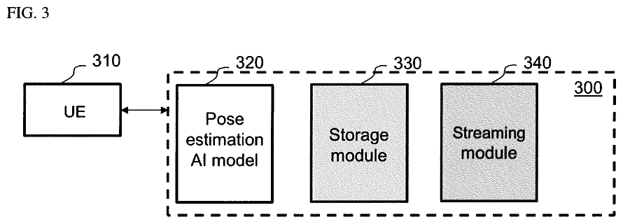

FIG. 3 illustrates a streaming system to which the present specification may be applied.

Referring to FIG. 3, the streaming system may include a terminal 310 and a server 300. The server 300 may be implemented in the form of a cloud server. More specifically, the server 300 may include a pose estimation AI model 320 configured to analyze a posture or movement of the target in the video frame, a storage module 330 configured to store and manage segment data and an AI computation result, and a streaming module 340 configured to provide the analyzed video data in real time, which may be controlled through a management module (not shown).

The terminal 310 may mean a client device on which the user uploads video data and receives an analysis result. For example, various devices such as a mobile device, a tablet, and a PC may serve as the terminal 310 and interact with the server 300 through a user interface (UI). When the user selects video and starts uploading, the terminal 310 may process video data in units of segments through the server 300 by using a streaming protocol.

Through the terminal 310, the user may issue a play request (e.g., to view results from the beginning) or a seek request (e.g., to move to a specific time zone), and may visualize the processed results received from the server 300 in real time.

The pose estimation AI model 320 may extract the posture or movement of the target from video frames. When video segments uploaded to the server 300 are input, necessary data may be extracted from each frame.

The pose estimation AI model 320 may perform computation in frame unit, and the estimated results may be stored, for each segment, in a pose result array. These results may be stored in the storage module 330 and may be provided to the streaming module 340 when needed. In addition, frames that have already been analyzed may reuse the results to prevent redundant processing.

The storage module 330 may store and manage the video segment data and the computation result of the pose estimation AI model 320. For example, when the video uploaded from the terminal 310 is separated into segment units, each segment may be stored in memory or on disk and managed through metadata. In addition, after the AI computation is completed, the pose estimation results for each frame may also be stored in the storage.

The streaming module 340 may provide the analyzed video data in real time according to a play or seek request of the terminal 310. For example, when the user requests the result for a specific time zone, the server 300 may retrieve the segment for that time zone and pose estimation result from the storage module 330 and send them to the terminal 310.

If a request is made for a segment that has not been processed, the streaming module 340 may rapidly complete the processing through the pose estimation AI model 320 and transmit the result to the terminal 310.

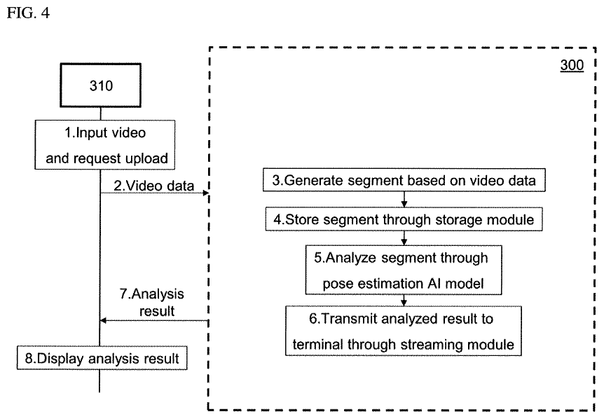

FIG. 4 illustrates an upload process to which the present specification may be applied.

Referring to FIG. 4, a user may input the video through the terminal 310, and request an upload to the server 300, thereby checking the analysis result of the video in question.

### 1. Inputting Video and Requesting Upload

The user may select the video and request upload through the terminal 310. Through this request, the terminal 310 may be connected with the server for the video file, enabling real-time streaming sending. More specifically, the streaming protocol may be activated together with metadata (e.g., video length, resolution, etc.) to upload the video to the server 300.

### 2. Sending the Video Data to Server

Based on the upload request, the terminal 310 sends the video data to the server 300. Thereafter, the server 300 may be structured to segment the data while receiving each frame of the video simultaneously.

### 3. Generating the Segment Based on Video Data

The server 300 may manage the video data by segmenting it into in a certain time unit (for example, 2 seconds). The segments are designed to be individually accessible and analyzable, and a unique identifier may be assigned to each segment.

For example, the server 300 may further generate a metadata file (e.g., .m3u8) to record the start point and length of each segment. Through this, when it is necessary to analyze the video for a specific time zone, the server 300 may quickly access that zone.

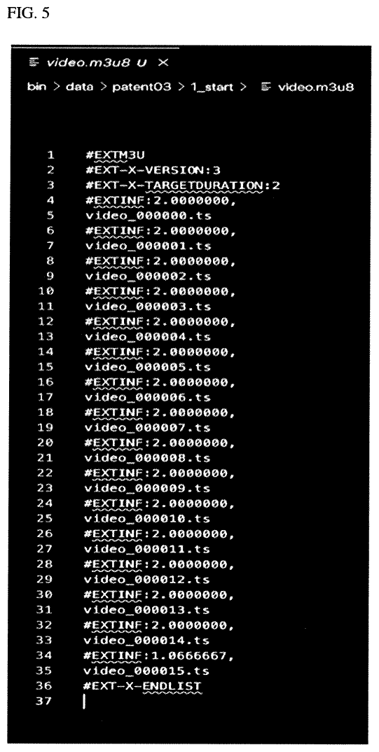

FIG. 5 illustrates metadata to which the present specification may be applied.

The metadata file may be configured in a Hypertext Live Streaming (HLS) format, and may record the length of segment and a file name of that segment.

Referring to FIG. 5, in a video.m3u8 file, a duration of each segment may be indicated by using a #EXTINF tag, and a subsequent file name (video_000000.ts or the like) may indicate each segment. In addition, #EXTINF: 2.0000000 may mean that the segment is 2 seconds long, and this structure allows all segments to be managed in time units. The last segment may be shorter than 2 seconds depending on the remaining length of the video. Through this, the server 300 may quickly search for and analyze the video for specific time zone.

### 4. Storing the Segment Through Storage Module

Referring again to FIG. 4, the generated segments are stored in the storage module 330. The stored segments may be stored in memory or disk as needed, and frequently referenced segments may be cached in memory. With such storage, AI analysis and quick data access upon user request may be ensured, and segments that have been analyzed may be managed without redundant storage.

### 5. Analyzing the Segment Through Pose Estimation AI Model

The stored segments are transmitted to the pose estimation AI model 320 so that each frame may be analyzed. For example, the pose estimation AI model 320 may analyze the motion or pose of the target using a YOLO-based object detection or PoseNet algorithm. The analysis result is stored in the pose result array of the storage module 330, in units of each frame, and then may be immediately responded to the user's request through the streaming module 340.

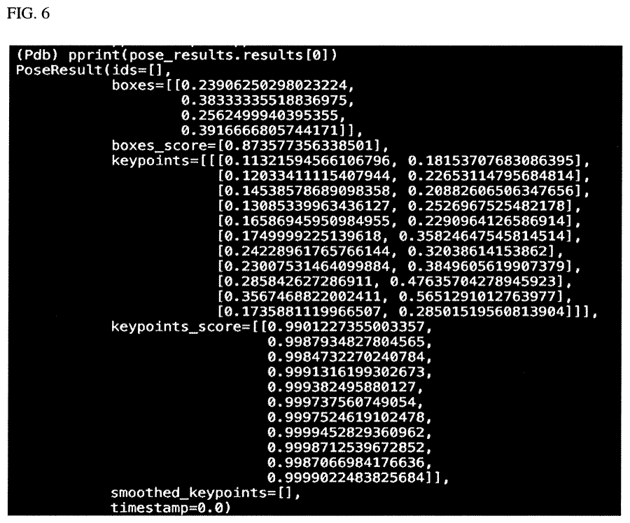

FIG. 6 illustrates a Pose Result array to which the present specification may be applied.

Referring to FIG. 6, the pose result array may store whether each frame is processed and a corresponding result. For example, an array having a length equal to the video length may be generated, and in an initial state, all elements may be set to None, which may indicate a frame that has not yet been analyzed.

When a frame has been analyzed by the pose estimation AI model 320, a pose result may be assigned to the index of that frame. Through this array, the portion containing None may indicate a frame that has not yet been processed, and the portion containing pose result value may mean a frame that has been processed.
Example 1: [None, None, None, . . . , None] (all frames not processed)
Example 2: [Pose Result, Pose Result, None, Pose Result, . . . , None] (partially processed frame)
Example 3: [Pose Result, Pose Result, Pose Result, . . . , Pose Result] (all frames are processed).

Each pose result may include information such as bounding boxes of the object, coordinates of keypoints (keypoints), and confidence scores of the keypoints (keypoints_score). Through this, detailed information on the position, posture, and movement of the object may be stored for each frame, and when the user requests the analysis result of a specific frame, it may be provided immediately.

### 6. Sending the Result Through Streaming Module

Referring back to FIG. 4, the analyzed data may be transmitted to the streaming module 340 and sent to the terminal 310. If there is the user request, the result that has already been analyzed may be returned immediately, and the segment that has not yet been processed may be immediately analyzed through the pose estimation AI model 320.

### 7. Sending and Displaying the Analysis Result to Terminal

The analysis result is sent to the terminal 310, allowing the user to check the result in real time. The user may immediately check the pose estimation result in a specific time zone of the video, and when an additional upload request occurs, the process in question may be restarted.

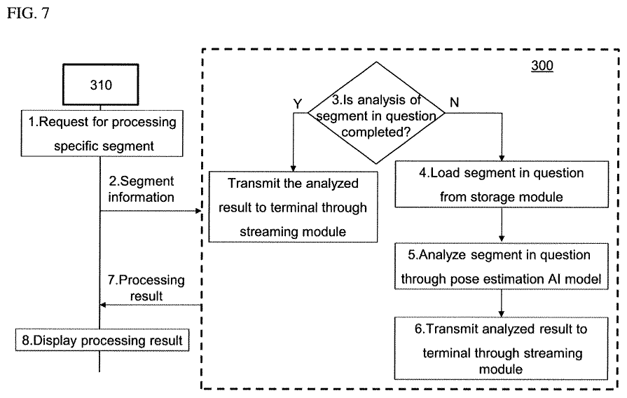

FIG. 7 illustrates a computing process to which the present specification may be applied.

Referring to FIG. 7, the user may input a seek or play command to the terminal 310, request the analysis result of the specific segment from the server, and immediately check the processing result.

### 1. Requesting for Processing the Specific Segment

In order for the user to check the analysis result for a specific time zone, the terminal 310 may request the server 300 to process that segment. The user may request the analysis result of the specific segment from the server through the seek or play command, and this request may be transmitted to the server 300 through the real-time streaming protocol.

### 2. Transmitting Segment Information to Server

The segment information transmitted from the terminal 310 is input to the streaming module 340, and the server 300 may first check whether that segment has already been processed. For example, the segment information may include information on a start time, so as to identify a zone of the segment of the video.

3. Checking of Whether Segment has been Analyzed

Based on the segment information, the streaming module 340 may retrieve the pose result array stored in the storage module 330 to check whether the analysis of that segment has been analyzed. If the segment has already been processed, the analysis result may be immediately returned to the terminal requested by the user. If the segment has not yet been processed, a procedure for loading that segment from the storage module 330, as described below, may be performed for AI computation. This may prevent redundant computation and maximize the resource efficiency of the system.

4. Loading Segment from Storage Module

A segment determined to require analysis is loaded from the storage module 330. Since each segment is divided and stored in a predetermined time unit, the required segment may be quickly retrieved. The loaded segment is transferred to memory to prepare for processing by the pose estimation AI model 320.

### 5. Analyzing Segment Through Pose Estimation AI Model

The pose estimation AI model 320 analyzes the loaded segment in units of each frame. The analysis result may be organized in forms such as boxes, keypoints, keypoints_score, and the result for that frame may be stored in the pose result array. Through this, the analysis result may be optimized to enable immediate response to subsequent user requests.

### 6. Transmitting the Analysis Results to Terminal Through Streaming Module

The result of the analyzed segment is sent to the terminal 310 through the streaming module 340. The streaming module 340 may utilize metadata to transmit the analysis result of the required time zone in real time. Finally, the user may check the analysis result of that segment without delay.

### 7. Transmitting and Displaying the Processed Result

The streamed analysis result is visually displayed on the terminal 310, allowing the user to check the AI analysis result for a specific time zone in real time. If an additional seek request occurs, the computing process may be repeated.

The following Table 1 is an example of a method for processing seek and play requests in a computing process to which the present specification may be applied.

```
TABLE 1
#Initialize pose_results array with the same length as the video
pose_results = [None] * video_length
# Set initial state
frame_num = 0
process_status = ‘PLAY’
last_played = 0 # Record the last processed frame number
while frame_num < video_length:
  # If the current frame has already been processed, move to the next frame
  if pose_results[frame_num] is not None;
    frame_num +=
    1continue
  # Retrieve frame data and analyze with the AI model
  frame = get_frame(m3u8_file, frame_num)
  pose_result = estimate(frame)
  pose_results[frame_num] = pose_result # Store the analysis result
  # If in PLAY state, record the last processed frame
  if process_status == ‘PLAY’
    last_played = frame_num
  # Check whether there is a seek request from the user
  if seek_request_exists( ):
    process_status = ‘SEEK’
    frame_num = get_frame_num_from_seek_request( ) # move to the requested frame
  # If in SEEK state and the last frame is reached, switch to PLAY state
  if process_status == ‘SEEK’ and frame_num == video_length − 1:
    process_status = ‘PLAY’
    frame_num = last_played # Return to the last processed position
  # Move to the nextframe
  frame_num += 1
```

Referring to Table 1, the code in question is structured to effectively process seek and play requests in order to allow the user to quickly check the analysis result for a specific time zone of the video. For example, during the initialization stage, the array pose_results that stores the analysis state of each frame is set to None for all elements, and the result is stored in the that frame when the AI analysis is completed.

The initial state is set to process_status=‘PLAY’ so that the video may be played sequentially. For example, the play request may correspond to a case where the user requests normal video playback without a separate command. In this state, frames are sequentially analyzed, and when the unanalyzed frame (pose_results [frame_num]==None) is found, the get_frame ( ) function may be called to obtain frame data, and AI analysis may be performed. The result is stored in pose_results, and the analyzed frame number may be recorded inlast_played.

A seek request may occur when a user wishes to immediately check the results for a specific time zone. The server 300 may call seek_request_exists ( ) each time to detect the user request, and if requested, change process_status to ‘SEEK’ to move to the specific frame number requested by the user. The server 300 may preferentially analyze the frame for that zone, thereby ensuring a quick response to an important zone.

The return to the play state may be made after the seek request ends. When all the zone requested by the user are processed, the server 300 may switch process_status back to ‘PLAY’, and return to the previously last processed frame number (last_played) to continue the analysis. This state switching structure allows flexibly response to the user request even during real-time streaming, while managing overall video analysis and priority processing of a specific zone in a balanced manner. As a result, the user may quickly search the analysis result from the start time point of video uploading and check desired portions without interruption.

The foregoing specification may be implemented as computer-readable code on a medium in which a program is recorded. The computer-readable medium includes all types of recording devices in which data readable by a computer system is stored. Examples of the computer-readable medium include a hard disk drive (HDD), a solid state disk (SSD), a silicon disk drive (SDD), ROM, RAM, CD-ROM, a magnetic tape, a floppy disk, an optical data storage device, and the like, and also include those implemented in the form of a carrier wave (e.g., send through the internet). Accordingly, the above detailed description should not be construed as limiting in all aspects but should be considered as illustrative. The scope of the present specification should be determined by a reasonable interpretation of the appended claims, and all changes within the equivalent scope of the present specification are intended to be included in the scope of the present specification.

In addition, although the foregoing description has been made with reference to services and embodiments, it is merely illustrative and not intended to limit the present specification, and it will be understood by those skilled in the art to which this specification pertains that various modifications and applications not exemplified above are possible without departing from the essential characteristics of the services and embodiments. For example, each component specifically shown in the embodiments may be modified and implemented. And such differences relating to the modifications and applications shall be construed as being included in the scope of the present specification as defined by the appended claims.

What is claimed is:

1. A method for analyzing and streaming videos without upload delay by a server, comprising:
receiving, from a terminal, the videos;
generating a segment based on the data of the videos;
storing the segment;
analyzing the segment; and
transmitting an analysis result of the segment to the terminal.

2. The method of claim 1, wherein the generating the segment comprises:
dividing the videos in a fixed time unit.

3. The method of claim 1, wherein the analyzing the segment comprises:
displaying an analysis completion in an item corresponding to the segment based on an array for indicating that analysis of the segment has been completed.

4. The method of claim 3, wherein the analyzing the segment comprises:
estimating a pose of the target through a pose estimation AI model for each frame included in the segment.

5. The method of claim 3, further comprising:
receiving, from the terminal, a request for processing a specific segment;
checking whether the analysis of the specific segment has been completed; and
when the analysis of the specific segment has been completed, transmitting the analysis result of the specific segment to the terminal.

6. The method of claim 5, further comprising:
when the analysis of the specific segment has not been completed, loading the specific segment;
analyzing the specific segment; and
transmitting the analysis result of the specific segment to the terminal.

7. The method of claim 6, wherein the checking whether the analysis of the specific segment has been completed comprises:
retrieving an item corresponding to the specific segment based on the array.

8. The method of claim 7, further comprising:
performing the analysis, starting from the last processed frame number.

9. A server for analyzing and streaming videos without upload delay, comprising:
a pose estimation AI model configured to analyze the videos;
a storage module, configured to store segment data and an analysis result of the videos;
a streaming module configured to provide the analyzed video data in real time; and
a processor configured to functionally control the pose estimation AI model, the storage module, and the streaming module;
wherein the processor is configured to:
receive, from a terminal, the videos, generate, store, and analyze the segment based on data of the videos, and transmit the analysis result of the segment to the terminal.
